(19) United States
(12) Patent Application Publication
(10) Pub. No.: US 2004/0257427 A1
(43) Pub. Date: Dec. 23, 2004

(54) Image forming apparatus and correction method for image forming apparatus

(76) Inventors: Tsumoru Fukushima, Kyoto (JP); Haruo Yamashita, Osaka (JP); Toshiyuki Wada, Osaka (JP); Tetsuya Morita, Osaka (JP)

Correspondence Address: Neil A. DuChez, Renner, Otto, Boisselle & Sklar, LLP, Nineteenth Floor, 1621 Euclid Avenue, Cleveland, OH, 44115-2191, US

(21) Appl. No.: 10/703,108

(22) Filed: Nov. 6, 2003

(30) Foreign Application Priority Data
Nov. 7, 2002 (JP) 2002-324468

(51) Int. Cl. B41J 17/28; B41J 17/30; B41J 2/325

(52) U.S. Cl. 347/217

(57) ABSTRACT

An image forming apparatus is provided, which comprises a dye transfer section for transferring a dye of a dye transferring member onto an outer surface of a circularly moving recording intermediate belt, wherein the dye transferring member comprises a base material and the dye is provided on the base material; and a recording paper transfer section for transferring the dye transferred onto the recording intermediate belt onto recording paper. In a dye transfer operation state, the second roller draws out the dye transferring member and the dye on the drawn dye transferring member is transferred onto the recording intermediate belt facing the dye transferring member. When the dye transfer operation state is changed to a standby state, the first roller winds back the dye transferring member so that a portion of the dye transferring member from which the dye has been transferred faces the recording intermediate belt.

### BACKGROUND OF THE INVENTION

1. Field of the Invention

The present invention relates to an image forming apparatus for forming images and a correction method for the image forming apparatus.

2. Description of the Related Art

Dye thermal transfer recording methods have been used to form images which have as high quality as color photographs. Particularly, an offset dye thermal transfer recording method has attracted attention. An image forming apparatus with the offset dye thermal transfer recording method typically employs an endless recording intermediate belt. The recording intermediate belt is wound around a platen drum and is moved at a predetermined rate (e.g., see Japanese Laid-Open Publication No. 2002-79698).

A dye mounting layer transfer section is provided around the platen drum, which transfers a dye mounting layer to a region which will become an image forming region of a recording intermediate belt. A dye mounting layer transfer head of the dye mounting layer transfer section presses a dye mounting layer transferring member, which is drawn out from a roll of a dye mounting layer transferring member wounded in the dye mounting layer transfer section, onto the region which will become an image forming region of a recording intermediate belt, for the purpose of transfer.

A plurality of dye transfer sections are disposed around the platen drum, which transfer respective dyes so as to form different color images. The dye transfer head of each dye transfer section performs an image forming operation based on image data to form a different color image while pressing a dye transferring member thereof, which is drawn out from a roll of dye transferring member wounded in the dye transfer section, onto the dye mounting layer of an image forming region. Images having a different color produced by their respective dye transfer sections form a full-color image on the dye mounting layer.

The full-color image formed on the dye mounting layer of the recording intermediate belt is transferred together with the dye mounting layer to a sheet of recording paper, which is drawn out from a roll of recording paper, by a recording paper transfer head. The recording paper having the full-color image transferred is peeled off the recording intermediate belt, and is cut into predetermined sizes by a cutting mechanism provided in a cutting section. The cut paper is ejected from the image forming section.

Conventional image forming apparatuses have the following problems.

The image forming section of the image forming apparatus transfers a dye to an image forming region of recording paper in a dye transfer operation state and does not perform the transfer operation in a standby state. In the dye transfer operation state a dye transferring member is continuously drawn out from a roll of each wound dye transferring member onto each dye transfer section, while in the standby state a dye transferring member is not drawn and there is a risk that dust will become attached to the dye transferring member. When the state of the image forming section is changed from the standby state to the dye transfer operation state, a dye on the dye transferring member having dust attached thereon is likely to be transferred onto the dye mounting layer of the recording intermediate belt, so that a formed image is unclear.

A mark indicating an end of the dye can be attached to a dye on the dye transferring member. By detecting the mark, it is possible to determine that all dye on the dye transferring member has been used. Dye layer transferring members cannot be marked with any mark to indicate the end of the dye mounting layer. Therefore, it is not possible to detect when the entire dye mounting layer has been used. In this case, image formation is continued even when the entire dye mounting layer has been used. There is a risk that the dye mounting layer will not be transferred so that recording paper without transferred dye is provided for the user.

In addition, even when exhaustion of dye on a dye transferring member is detected by means of a mark indicating an end which is attached to the dye on the dye transferring member, there is a risk that an incomplete image without transferred dye is provided to the user.

When the temperature of at least one of the dye mounting layer transfer head, the dye transfer heads, and the recording paper transfer head exceeds a predetermined temperature, the dye mounting layer transfer head, the dye transfer heads, and the recording paper transfer head are put into a cooling state to cool them. Although transfer is performed where the dye mounting layer transfer head, the dye transfer heads, and the recording paper transfer head are heated, if they are heated to a temperature more than a predetermined temperature, transfer is hindered.

However, even when the number of remaining paper sheets to be subjected to image transfer is small (e.g., less than 4 sheets), if the temperature of at least one of the dye mounting layer transfer head, the dye transfer heads, and the recording paper transfer head exceeds a predetermined temperature, they are put into the cooling state. In this case, the user has to wait until cooling of the dye mounting layer transfer head, the dye transfer heads, and the recording paper transfer head has finished.

In recording paper, an image forming region in which an image is formed and a non-image forming region in which no image is formed are arranged alternately along a transporting direction. Since only image forming regions in which an image is formed are provided to the user, non-image forming regions are cut as unnecessary sections in image forming apparatuses. Non-image forming regions are cut into a plurality of cut pieces by a cutting section. The cut pieces are accommodated via an opening portion into a cut piece accommodating section provided below the opening portion. The non-image region of recording paper is cut into cut pieces, each of which has a size such that the piece can pass through the opening portion, along a direction perpendicular to the transporting direction of the recording paper at predetermined intervals. However, the length of a non-image forming region along the transporting direction recording paper may vary depending on the length of an image forming region. When a non-image forming region of recording paper is cut into a plurality of pieces at predetermined intervals, there is a risk that the last cut piece has such a short width that it becomes jammed in the cutting section.

Cut pieces fall into the cut piece accommodating section provided below the opening portion, i.e., the cut pieces are accommodated in the accommodating section. The cut piece accommodating section is provided with a cut piece fullness detecting section which determines whether or not the amount of cut pieces accommodated in the cut piece accommodating section exceeds a predetermined level, based on the interception of emitted light. If light is intercepted by cut pieces accommodated in the cut piece accommodating section, the cut piece fullness detecting section that the amount of cut pieces accommodated in the cut piece accommodating section exceeds a predetermined level.

However, light emitted from the cut piece fullness detecting section may possibly be intercepted by a small number of cut pieces falling into the cut piece accommodating section. In this case, even if the amount of cut pieces accommodated in the cut piece accommodating section does not exceed a predetermined level, it is likely to be otherwise determined, i.e., it is erroneously determined that the amount of cut pieces accommodated in the cut piece accommodating section exceeds a predetermined level.

Cut pieces which have fallen through the opening portion are sparsely accommodated in the cut piece accommodating section. Therefore, even if the actual amount of cut pieces is not so large, the cut piece accommodating section is rapidly determined to be full. It is necessary to frequently discard cut pieces accommodated in the cut piece accommodating section.

Image forming apparatuses fabricated in the same manner may form slightly different concentrations due to variations of image forming apparatuses derived from manufacture. To adjust such concentrations, a voltage to be applied to each dye transfer head is adjusted before shipment of the image forming apparatuses. In this case, the resistance of a circuit for driving each dye transfer head has been adjusted.

The present invention is provided to solve the above-described problems. An object of the present invention is to provide an image forming apparatus in which a dye transferring member having dust attached thereon in its standby state is prevented from being used to form images.

Another object of the present invention is to detect an end of a dye mounting layer transferring member.

Another object of the present invention is to provide an image forming apparatus which does not provide to the user an image to which a dye of a dye transferring member is not transferred due to exhaustion of the dye.

Another object of the present invention is that even when at least one of a dye mounting layer transfer head, dye transfer heads, and a recording paper transfer head exceeds a predetermined temperature, the number of remaining images is taken into consideration and the remaining images are formed if the number of the remaining images is small; and after the remaining images are formed, the dye mounting layer transfer head, the dye transfer heads, and the recording paper transfer head are put into a cooling state.

Another object of the present invention is that when recording paper having image forming regions and non-image forming regions which are arranged alternately along the transporting direction is cut by a cutting section a plurality of times in the non-image forming regions along a direction substantially perpendicular to the transporting direction, the cutting section can cut the recording paper into cut pieces such that the width of each cut pieces is greater than a minimum width of cut pieces which can be obtained by the cutting section and is smaller than a predetermined width.

Another object of the present invention is to avoid erroneously determining that the amount of cut pieces accommodated in the cut piece accommodating section exceeds a predetermined level in the situation where falling cut pieces intercept light for determining whether or not the amount of cut pieces accommodated in a cut piece accommodating section exceeds a predetermined level.

Another object of the present invention is to prevent cut pieces from being sparsely accommodated in a cut piece accommodating section, thereby making it possible to avoid the situation that the cut piece accommodating section is frequently detected as being full.

Another object of the present invention is to adjust variations of the density of transferred dye due to manufacturing variations of image forming apparatuses without adjusting a voltage applied to the dye transfer head.

### SUMMARY OF THE INVENTION

According to an aspect of the present invention, an image forming apparatus is provided, which comprising: a dye transfer section for transferring a dye of a dye transferring member onto an outer surface of a circularly moving recording intermediate belt, wherein the dye transferring member comprises a base material and the dye is provided on the base material; and a recording paper transfer section for transferring the dye transferred onto the recording intermediate belt onto recording paper. The dye transfer section comprises a first roller and a second roller, wherein the dye transferring member is wound around the first roller, and the second roller draws out the dye transferring member from the first roller. In a dye transfer operation state, the second roller draws out the dye transferring member and the dye on the drawn dye transferring member is transferred onto the recording intermediate belt facing the dye transferring member. The dye transfer operation state is changed to a standby state, the first roller winds back the dye transferring member so that a portion of the dye transferring member from which the dye has been transferred faces the recording intermediate belt.

In one embodiment of this invention, when the standby state is changed to the dye transfer operation state, the second roller draws out the dye transferring member so that a portion of the dye transferring member from which the dye has not been transferred faces the recording intermediate belt.

According to another aspect of the present invention, an image forming apparatus is provided, which comprises: a dye mounting layer transfer section for transferring a dye mounting layer of a dye mounting layer transferring member onto an outer surface of a circularly moving recording intermediate belt, wherein the dye mounting layer transferring member comprises a base material and the dye mounting layer is provided on the base material; a dye transfer section for transferring a dye of a dye transferring member onto the dye mounting layer, wherein the dye transferring member comprises a base material and the dye is provided on the base material; and a recording paper transfer section for transferring the dye transferred onto the recording intermediate belt onto recording paper. The dye mounting layer transfer section comprises a first roller and a second roller, wherein the dye mounting layer transferring member is wound around the first roller, and the second roller draws out the dye mounting layer transferring member from the first roller. An end of the dye mounting layer transferring member is detected by determining a remaining amount of the dye mounting layer transferring member wound around the first roller based on a rotational rate of the second roller.

According to another aspect of the present invention, an image forming apparatus is provided, which comprises: a plurality of dye transfer sections for transferring dyes of respective dye transferring members onto an outer surface of a circularly moving recording intermediate belt, wherein each dye transferring member comprises a base material and the dye is provided on the base material; a recording paper transfer section for transferring the dyes transferred onto the recording intermediate belt in sequence onto transported recording paper drawn out from a roll of the recording paper, wherein image forming regions are spaced by non-image forming regions, the dyes are transferred into the respective image forming regions and the dyes are not transferred into the non-image forming regions; and a cutting section for cutting the recording paper having the dye transferred thereon by the recording paper transfer section into the image forming regions. Each dye transfer section comprises a dye transferring member exhaustion detecting section for detecting when the dye of the dye transferring member thereof is exhausted. When any one of the dye transferring member exhaustion detecting sections detects dye exhaustion, the cutting section cuts an image forming region of the recording paper on which an image is formed with the dyes of the dye transferring members other than the exhausted dye of the dye transferring member.

According to another aspect of the present invention, an image forming apparatus is provided, which comprises: a dye mounting layer transfer section for transferring a dye mounting layer of a dye mounting layer transferring member onto an outer surface of a circularly moving recording intermediate belt using a heated dye mounting layer transfer head, wherein the dye mounting layer transferring member comprises a base material and the dye mounting layer is provided on the base material; a dye transfer section for transferring a dye of a dye transferring member onto the dye mounting layer using a heated dye transfer head, wherein the dye transferring member comprises a base material and the dye is provided on the base material; and a recording paper transfer section for transferring the dye transferred onto the dye mounting layer onto recording paper using a recording paper transfer head. Temperature sensors are provided for detecting temperatures of the dye mounting layer transfer head, the dye transfer head, and the recording paper transfer head, respectively. The number of remaining images to be formed is specified. The image forming apparatus is put into a cooling state, where the dye mounting layer transfer head, the dye transfer head, and the recording paper transfer head are cooled, based on at least one of the temperatures of the dye mounting layer transfer head, the dye transfer head, and the recording paper transfer head detected by the respective temperature sensors and the number of remaining images to be formed.

According to another aspect of the present invention, an image forming apparatus is provided, which comprises: a dye transfer section for transferring a dye of a dye transferring member onto an outer surface of a circularly moving recording intermediate belt, wherein the dye transferring member comprises a base material and the dye is provided on the base material; a recording paper transfer section for transferring the dyes transferred onto the recording intermediate belt in sequence onto transported recording paper drawn out from a roll of the recording paper, wherein image forming regions are spaced by non-image forming regions, the dyes are transferred into the respective image forming regions and the dyes are not transferred into the non-image forming regions; and a cutting section for cutting the recording paper having the dye transferred by the recording paper transfer section into the image forming regions. The cutting section cuts a non-image forming region of the recording paper in a direction substantially perpendicular to a transporting direction of the recording paper based on a length of the non-image forming region along the transporting direction.

According to another aspect of the present invention, an image forming apparatus is provided, which comprises: a dye transfer section for transferring a dye of a dye transferring member onto an outer surface of a circularly moving recording intermediate belt using a dye transfer head, wherein the dye transferring member comprises a base material and the dye is provided on the base material; a recording paper transfer section for transferring the dyes transferred onto the recording intermediate belt in sequence onto transported recording paper drawn out from a roll of the recording paper, wherein image forming regions are spaced by non-image forming regions, the dyes are transferred into the respective image forming regions and the dyes are not transferred into the non-image forming regions; a cutting section for cutting the recording paper having the dye transferred thereon by the recording paper transfer section into the image forming regions; a cut piece accommodating section for accommodating cut pieces generated by the cutting section; and a cut piece fullness detecting section for determining whether or not an amount of cut pieces accommodated in the cut piece accommodating section exceeds a predetermined level. The cut piece fullness detecting section suspends the determination operation for a predetermined period of time after the cutting operation of the recording paper and thereafter resumes the determination operation.

According to another aspect of the present invention, an image forming apparatus is provided, which comprises: a dye transfer section for transferring a dye of a dye transferring member onto an outer surface of a circularly moving recording intermediate belt, wherein the dye transferring member comprises a base material and the dye is provided on the base material; a recording paper transfer section for transferring the dyes, which has been transferred onto the recording intermediate belt, in sequence onto transported recording paper drawn out from a roll of the recording paper, wherein image forming regions are spaced by non-image forming regions, the dyes are transferred into the respective image forming regions and the dyes are not transferred into the non-image forming regions; and a cutting section for cutting the recording paper having the dye transferred thereon by the recording paper transfer section into the image forming regions; a cut piece accommodating section for accommodating cut pieces generated by the cutting section; and a cut piece fullness detecting section for determining whether or not an amount of cut pieces accommodated in the cut piece accommodating section exceeds a predetermined level. The cut piece fullness detecting section emits light to the cut pieces accommodated in the cut piece accommodating section at predetermined intervals, and based on a number of light interceptions, determines whether or not an amount of the cut pieces accommodated in the cut piece accommodating section exceeds a predetermined level.

According to another aspect of the present invention, an image forming apparatus is provided, which comprises: a dye transfer section for transferring a dye of a dye transferring member onto an outer surface of a circularly moving recording intermediate belt, wherein the dye transferring member comprises a base material and the dye is provided on the base material; a recording paper transfer section for transferring the dyes transferred onto the recording intermediate belt in sequence onto transported recording paper drawn out from a roll of the recording paper, wherein image forming regions are spaced by non-image forming regions, the dyes are transferred into the respective image forming regions and the dyes are not transferred into the non-image forming regions; a cutting section for cutting the recording paper having the dye transferred thereon by the recording paper transfer section into the image forming regions; a cut piece accommodating section for accommodating cut pieces generated by the cutting section; and a cut piece volume reducing section for reducing a volume of the cut pieces accommodated in the cut piece accommodating section.

According to another aspect of the present invention, a correction method for an image forming apparatus is provided. The image forming apparatus comprises: a dye transfer section for transferring a dye of a dye transferring member onto an outer surface of a circularly moving recording intermediate belt using a dye transfer head, wherein the dye transferring member comprises a base material and the dye is provided on the base material, and the dye transfer head is heated by applying a predetermined voltage thereto for a predetermined period of time; and a recording paper transfer section for transferring the dye transferred onto the recording intermediate belt onto recording paper. A reference dye transfer head as a reference for the dye transfer head is previously used to obtain a relationship among a density of a transferred dye, a period of voltage application time, and an applied voltage. The method comprises the steps: measuring a density of the dye transferred by the dye transfer head by applying a first voltage thereto for a first period of voltage application time; determining an appropriate voltage from the correction table based on the density measured by the measuring step and the first period of voltage application time; and controlling the dye transfer head based on the relationship between the density of the dye transferred by applying the determined voltage to the reference dye transfer head and the period of voltage application time.

These and other advantages of the present invention will become apparent to those skilled in the art upon reading and understanding the following detailed description with reference to the accompanying figures.

### BRIEF DESCRIPTION OF THE DRAWINGS

FIG. 1 is a schematic block diagram showing an image forming apparatus according to an embodiment of the present invention.

FIG. 2 is a schematic side view showing an image forming section of the image forming apparatus of FIG. 1.

FIG. 3 is a side view showing a schematic structure of a cutting section of the image forming apparatus of FIG. 1.

FIG. 4 is a schematic front view showing a rotary cutter section of the cutting section of FIG. 3.

FIG. 5A is a schematic plan view for explaining how images A to E are successively formed on image forming regions A to E of a recording intermediate belt.

FIG. 5B is a table for explaining how a dye mounting layer transfer head, a first dye transfer head, a second dye transfer head, a third dye transfer head, and a recording paper transfer head simultaneously transfer images onto image forming regions.

FIG. 6 is a graph showing a correction table for adjusting an image forming apparatus according to an embodiment of the present invention before shipment.

### DESCRIPTION OF THE PREFERRED EMBODIMENTS

Hereinafter, the present invention will be described by way of illustrative examples with reference to the accompanying drawings.

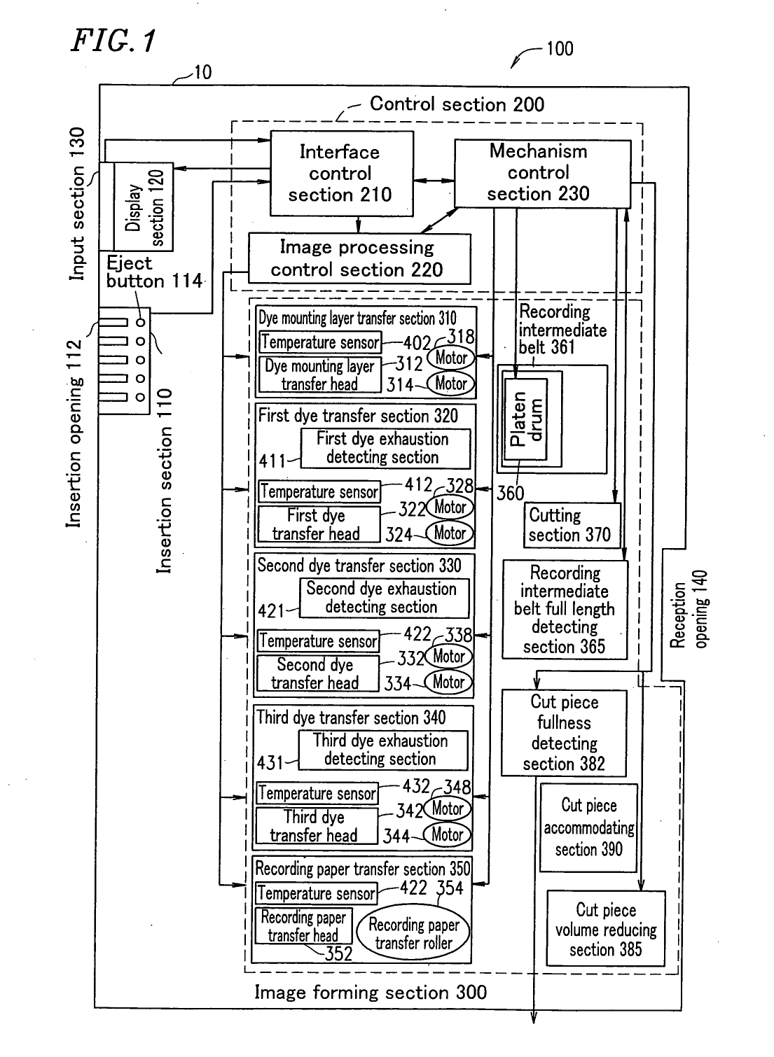

FIG. 1 is a schematic block diagram showing an image forming apparatus 100 according to an embodiment of the present invention. The image forming apparatus 100 comprises an image forming section 300 for forming an image and a control section 200 for controlling the image forming section 300. The image forming apparatus 100 has a housing 10. In the housing 10, the image forming section 300 and the control section 200 are provided.

On the front side of the housing 10, an insertion section 110 through which a recording medium is inserted, a display section 120 for displaying information for the user, an input section 130 through which an instruction is input from the user, and a reception opening 140 for providing an formed image to the user are provided.

The insertion section 110 is provided with five insertion openings 112 and five eject buttons 114. The insertion openings 112 each correspond to a respective eject button 114.

The insertion openings 112 respectively receives five types of recording media, i.e., a multimedia (MM) card, a smart media (SM) card, a compact flash® (CF) memory card, a PC card, and an MO disc.

By pressing the eject buttons 114 corresponding to their respective insertion openings 112, recording media inserted in the respective insertion openings 112 can be ejected.

The display section 120 displays various kinds of information from the image forming apparatus 100 to inform the user.

The user inputs information about an intended image to be formed via the input section 130 to the image forming apparatus 100. For example, the user inputs to the input section 130 the identification of image data among data recorded on a recording medium and the number of images to be formed based on the image data. Alternatively, the user inputs to the input section 130 information indicating whether or not an additional image is provided to an image from image data recorded in a recording medium and what the additional image is.

The image forming section 300 comprises an endless recording intermediate belt 361; a platen drum 360 for circularly moving the recording intermediate belt 361; a dye mounting layer transfer section 310 for transferring a dye mounting layer onto the circularly moving recording intermediate belt 361; a first dye transfer section 320 for transferring a first dye (yellow) onto the dye mounting layer of the recording intermediate belt 361; a second dye transfer section 330 for transferring a second dye (magenta) onto the dye mounting layer of the recording intermediate belt 361; a third dye transfer section 340 for transferring a third dye (cyan) onto the dye mounting layer of the recording intermediate belt 361; a recording paper transfer section 350 for transferring the dye mounting layer transferred onto the recording intermediate belt 361 and the first dye, second dye, and third dye transferred onto the dye mounting layer onto recording paper 351; a recording intermediate belt full length detecting section 365 for detecting the full length of the recording intermediate belt 361; a cutting section 370 for cutting the recording paper onto which the dye mounting layer, and the first, second, and third dyes have been transferred; a cut piece accommodating section 390 for accommodating cut pieces produced by the cutting section 370; a cut piece fullness detecting section 382 for determining whether or not the amount of cut pieces accommodated in the cut piece accommodating section 390 exceeds a predetermined level; and a cut piece volume reducing section 385 for reducing the volume of cut pieces accommodated in the cut piece accommodating section 390.

The dye mounting layer transfer section 310 comprises a dye mounting layer transfer head 312 for transferring the dye mounting layer of the dye mounting layer transferring member in a heated state onto the recording intermediate belt 361, a motor 314 for rotating a roller in a forward direction so as to wind a dye mounting layer transferring member, a motor 318 for rotating the roller in a backward direction so as to wind the dye mounting layer transferring member, and a temperature sensor 402 for detecting the temperature of the dye mounting layer transfer head 312.

The first dye transfer section 320 comprises a first dye transfer head 322 for transferring the first dye of the a first dye transferring member in a heated state onto the recording intermediate belt 361; a motor 324 for rotating a roller in a forward direction so as to wind the first dye transferring member; a motor 328 for rotating the roller in a backward direction so as to wind the first dye transferring member; a first dye exhaustion detecting section 411 for detecting when the first dye of the first dye transferring member has been exhausted; and a temperature sensor 412 for detecting the temperature of the first dye transfer head 322.

The second dye transfer section 330 comprises a second dye transfer head 332 for transferring a second dye of the second dye transferring member in a heated state onto the recording intermediate belt 361; a motor 334 for rotating a roller in a forward direction so as to wind the second dye transferring member; a motor 338 for rotating the roller in a backward direction so as to wind the second dye transferring member; a second dye exhaustion detecting section 421 for detecting when the second dye of the second dye transferring member has been exhausted; and a temperature sensor 422 for detecting the temperature of the second dye transfer head 332.

The third dye transfer section 340 comprises a third dye transfer head 342 for transferring a third dye of the third dye transferring member in a heated state onto the recording intermediate belt 361; a motor 344 for rotating a roller in a forward direction so as to wind the third dye transferring member; a motor 348 for rotating the roller in a backward direction so as to wind the third dye transferring member; a third dye exhaustion detecting section 431 for detecting when the third dye of the third dye transferring member has been exhausted; and a temperature sensor 432 for detecting the temperature of the third dye transfer head 342.

The recording paper transfer section 350 comprises a recording paper transfer head 352 for heating recording paper via the recording intermediate belt 361; a recording paper transfer roller 354 which rotates while interposing the recording intermediate belt 361 and the recording paper with the recording paper transfer head 352; and a temperature sensor 442 for detecting the temperature of the recording paper transfer head 352.

The control section 200 comprises an interface control section 210 for reading out image data recorded in a recording medium inserted into the insertion section 110 and controlling interaction with the user; an image processing control section 220 for processing the read image data and based on the processed image data, controlling the dye mounting layer transfer head 312, the first dye transfer head 322, the second dye transfer head 332, the third dye transfer head 342, and the recording paper transfer head 352; and a mechanism control section 230 for controlling the motors 314, 318, 324, 328, 334, 338, 344, 348, and 354, the platen drum 360, the recording intermediate belt full length detecting section 365, the cutting section 370, the cut piece fullness detecting section 382, the cut piece volume reducing section 385, the temperature sensors 402, 412, 422, 432, and 442, and the first dye exhaustion detecting section 411, the second dye exhaustion detecting section 421, and third dye exhaustion detecting section 431.

The interface control section 210 controls the display section 120 as to what information or image is displayed, and receives instructions input by the user via the input section 120.

The interface control section 210 receives an instruction input by the user, which relates to the number of images to be formed, via the input section 120, and functions along with the mechanism control section 230 to cause the image forming apparatus 300 to form this number of images. During the formation of images, the interface control section 210 and the mechanism control section 230 recognizes the number of images which have been formed so far and the number of remaining images to be formed.

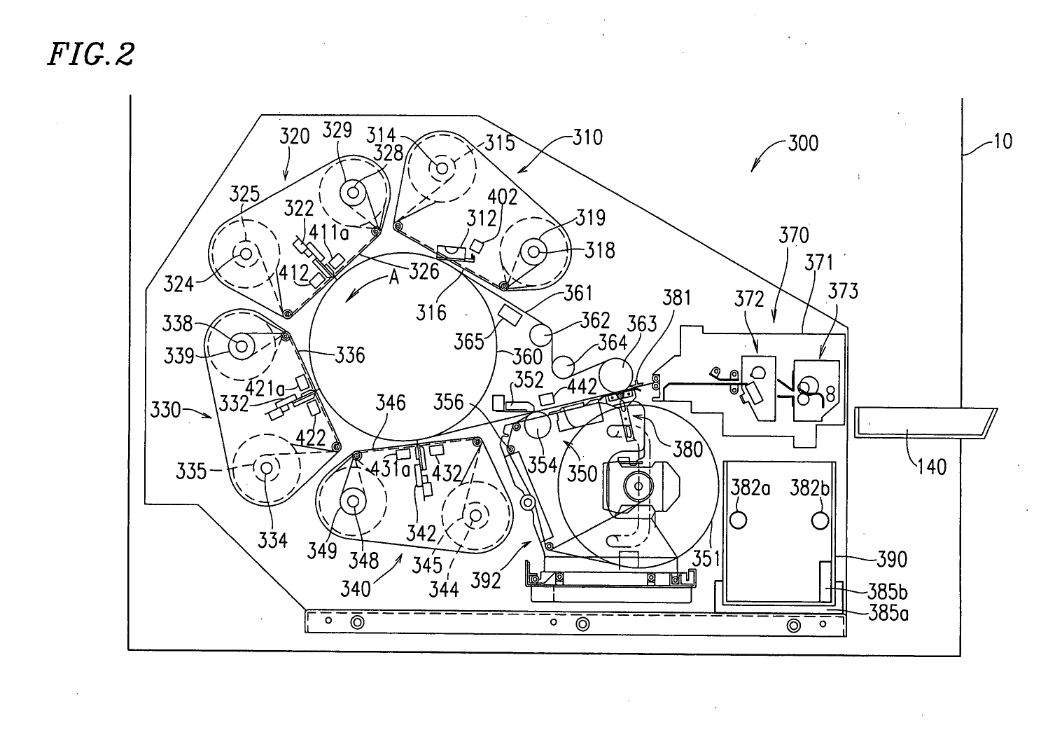

FIG. 2 is a schematic side view showing the image forming section 300 of the image forming apparatus 100 of the above-described embodiment of the present invention.

In the image forming section 300, the endless recording intermediate belt 361 is employed, which is circularly moved in a middle part of the image forming section 300. The recording intermediate belt 361 is, for example, a band-like belt made of polyimide film having a thickness of about 25 to about 50 μm where the opposite ends thereof are butt-joined so that the belt is endless.

The large-diameter (about 200 mm) platen drum 360 is provided at substantially the middle of the image forming section 300, around which the recording intermediate belt 361 is wound. The platen drum 360 is driven and rotated by a stepping motor in a direction indicated by arrow A in FIG. 2 accurately at a predetermined rate.

A rubber is provided on an outer surface of the platen drum 360. The recording intermediate belt 361 contacting the rubber is rotated accurately at a predetermined rate by frictional force between the belt and the rubber.

The length of the circle of the recording intermediate belt 361 around the platen drum 360 varies depending on the ambient temperature. However, the recording intermediate belt full length detecting section 365 can be used to detect the length of the circle of the recording intermediate belt 361.

A detectable mark is put on the recording intermediate belt 361. The recording intermediate belt 361 is circularly moved by the platen drum 360 to reach a predetermined moving rate. Thereafter, the mark on the recording intermediate belt 361 is detected twice by the recording intermediate belt full length detecting section 365. The rotational rate of the platen drum 360 is equal to the moving rate of the recording intermediate belt 361. Therefore, the mechanism control section 230 can detect the length of the circle of the recording intermediate belt 361 based on a period of time from the detection of the mark at a first time to the detection of the mark at a second time and the rotational rate of the platen drum 360. If necessary, the mechanism control section 230 changes the rotational rate of the platen drum 360 so as to achieve a desired moving rate of the recording intermediate belt 361.

An auxiliary roller 363 is provided to the side of the platen drum 360 so that the recording intermediate belt 361 is wound therearound. A tension is applied to the recording intermediate belt 361 circularly moving in a direction from the auxiliary roller 363 to the platen drum 360 by an idle roller 362 and a tension roller 364. The tension roller 364 provided proximal to the auxiliary roller 363 is moved toward or away from the outer surface of the recording intermediate belt 361.

The auxiliary roller 363 comprises a torque limiter, for example. The auxiliary roller 363 is rotated with a predetermined constant torque in the same direction as that of the platen drum 360, so that the recording intermediate belt 361 is circularly moved with a substantially constant torque.

One end portion of the auxiliary roller 363 can be moved up and down by a roller inclining mechanism. If the recording intermediate belt 361 wound around the auxiliary roller 363 is axially shifted with respect to the auxiliary roller 363, the auxiliary roller 363 is inclined with respect to a horizontal direction so that the end portion thereof opposite to the shift direction is positioned at the upper side. Thereby, the shift of the recording intermediate belt 361 with respect to the auxiliary roller 363 is cancelled.

The dye mounting layer transfer section 310 for transferring the dye mounting layer onto an outer surface of the recording intermediate belt 361 wound around the platen drum 360, is provided over the platen drum 360.

The dye mounting layer transfer section 310 comprises a roll of the dye mounting layer transferring member 316 which is made by providing a dye mounting layer on a base material. When the dye mounting layer transferring member 316 has been drawn out from the roll and faces the recording intermediate belt 361, the dye mounting layer of the dye mounting layer transferring member 316 is transferred onto the outer surface of the recording intermediate belt 361 by the dye mounting layer transfer head 312. The dye mounting layer is made of a resin having an excellent level of the ability to mount a dye. The base material of the dye mounting layer transferring member 316 from which the dye mounting layer has been transferred is taken up by the roller 315. The roller 315 is driven by the motor 314 controlled by the mechanism control section 230 to be rotated in a forward direction. The roller 319 around which the dye mounting layer transferring member 316 is wound is rotated in a forward direction by the rotation of the roller 315.

The dye mounting layer transfer head 312 is heated by applying a voltage thereto. The dye mounting layer of the dye mounting layer transferring member 316 is transferred onto the outer surface of the recording intermediate belt 361 by the heated dye mounting layer transfer head 312. The temperature of the dye mounting layer transfer head 312 is detected by the temperature sensor 402. The temperature of the dye mounting layer transfer head 312 is controlled so as not to exceed a predetermined temperature.

A mark indicating an end cannot be attached to the dye mounting layer transferr member 316. However, it can be detected when the dye mounting layer of the dye mounting layer transferring member 316 has been exhausted in the following manner. Since a roll of the dye mounting layer transferring member 316 wound around the roller 319 has a predetermined length, the mechanism control section 230 can calculate the remaining amount of the dye mounting layer transferring member 316 wound around the roller 319 based on the rotational rate of the roller 315 rotated by the motor 314.

The first dye transfer section 320 is provided downstream of the dye mounting layer transfer section 310 along the rotating direction of the platen drum 360, and transfers the first dye onto the dye mounting layer provided on the outer surface of the recording intermediate belt 361 by means of the dye mounting layer transfer section 310. The base material of the first dye transferring member 326 from which the first dye has been transferred by the first dye transfer head 322, is taken up by a roller 325. The roller 325 is rotated in a forward direction by the motor 324 driven by the control of the mechanism control section 230. A roller 329 around which the first dye transferring member 326 is wound is rotated in a forward direction by the rotation of the roller 325.

The first dye transfer head 322 is heated by applying a voltage thereto. The first dye of the first dye transferring member 326 is transferred onto the dye mounting layer on the outer surface of the recording intermediate belt 361 by the heated first dye transfer head 322. The temperature of the first dye transfer head 322 is detected by the temperature sensor 412. The temperature of the first dye transfer head 322 is controlled so as not to exceed a predetermined temperature.

The first dye exhaustion detecting section 411 detects when the first dye of the first dye transferring member 326 has been exhausted. The exhaustion of the first dye of the first dye transferring member 326 can be detected by a mark detecting section 411a. When a mark is attached at an end of the first dye transferring member 326, the mark detecting section 411a detects the mark to determine that the first dye of the first dye transferring member 326 has been exhausted. Alternatively, the exhaustion of the first dye of the first dye transferring member 326 can be detected by the rotation of the motor 324. When the first dye of the first dye transferring member 326 is exhausted, a roll of first dye transferring member 326 wound around the roller 329 is substantially completely unwound. In this case, the rotation of the roller 329 is stopped and thus the rotation of the roller 325 is also stopped. Although the motor 324 tries to drive the roller 325, the rotation of the roller 325 is stopped. Therefore, the motor 324 can detect when the first dye of the first dye transferring member 326 has been exhausted.

The second dye transfer section 330 is provided downstream of the first dye transfer section 320 along the rotating direction of the platen drum 360, which transfers the second dye onto the dye mounting layer provided on the outer surface of the recording intermediate belt 361. A roller 335 of the second dye transfer head 332 takes up the base material of the second dye transferring member 336 from which the second dye has been transferred. The roller 335 is rotated in a forward direction by the motor 334 driven by the control of the mechanism control section 230. A roller 339 around which the second dye transferring member 336 is wound is rotated in a forward direction by the rotation of the roller 335.

The second dye transfer head 332 is heated by applying a voltage thereto. The second dye of the second dye transferring member 336 is transferred onto the dye mounting layer provided on the outer surface of the recording intermediate belt 361 by means of the heated second dye transfer head 332. The temperature of the second dye transfer head 332 is detected by the temperature sensor 422. The temperature of the second dye transfer head 332 is controlled so as not to exceed a predetermined temperature.

The second dye exhaustion detecting section 421 detects when the second dye of the second dye transferring member 336 has been exhausted. The exhaustion of the second dye of the second dye transferring member 336 can be detected by a mark detecting section 421a. When a mark indicating an end is attached to the second dye transferring member 336, the exhaustion of the second dye of the second dye transferring member 336 can be detected by the mark detecting section 421a detecting the mark. Alternatively, the exhaustion of the second dye of the second dye transferring member 336 can be detected by the rotation of the motor 334. When the second dye of the second dye transferring member 336 is exhausted, a roll of the second dye transferring member 336 wound around the roller 339 is substantially completely unwound. In this case, the rotation of the roller 339 is stopped and thus the rotation of the roller 335 is also stopped. Although the motor 334 tries to rotate the roller 335, the rotation of the roller 335 is stopped. Therefore, the motor 334 can detect the exhaustion of the second dye of the second dye transferring member 336.

The third dye transfer section 340 is provided downstream of the second dye transfer section 330 along the rotating direction of the platen drum 360, which transfers the third dye on the dye mounting layer provided on the outer surface of the recording intermediate belt 361. The base material of the third dye transferring member 346 from which the third dye is transferred by the third dye transfer head 342, is taken up by the roller 345. The roller 345 is rotated in a forward direction by the motor 344 controlled by the mechanism control section 230. The roller 349 around which the third dye transferring member 346 is wound is rotated in a forward direction by the rotation of the roller 345.

The third dye transfer head 342 is heated by applying a voltage thereto. The third dye of the third dye transferring member 346 is transferred onto the dye mounting layer provided on the outer surface of the recording intermediate belt 361 by the heated third dye transfer head 342. The temperature of the third dye transfer head 342 is detected by the temperature sensor 432. The temperature of the third dye transfer head 342 is controlled so as not to exceed a predetermined temperature.

The third dye exhaustion detecting section 431 detects that the third dye of the third dye transferring member 346 has been exhausted. The exhaustion of the third dye of the third dye transferring member 346 can be detected by the mark detecting section 431a. When a mark indicating an end is attached to an end of the third dye transferring member 346, the mark detecting section 431a can detect the exhaustion of the third dye of the third dye transferring member 346 by detecting the mark. Alternatively, the exhaustion of the third dye of the third dye transferring member 346 can be detected by the rotation of the motor 344. When the third dye of the third dye transferring member 346 is exhausted, a roll of third dye transferring member 346 wound around the roller 349 is substantially completely unwound. In this case, the rotation of the roller 349 is stopped and thus the rotation of the roller 345 is also stopped. Although the motor 344 tries to drive the roller 345 to rotate, the rotation of the roller 345 is stopped. Therefore, the motor 344 can detect the exhaustion of the third dye of the third dye transferring member 346.

When the control section 200 (FIG. 1) detects the exhaustion of dye of any one of the first dye transferring member 326, the second dye transferring member 336, and the third dye transferring member 346, the control section 200 cuts an incomplete image, to which the dye has not been transferred, using the cutting section 370. Thereby, the incomplete image can be prevented from being provided to the user.

The first dye transfer section 320, the second dye transfer section 330, and the third dye transfer section 340 have a roll of first dye transferring member 326, a roll of second dye transferring member 336, and a roll of third dye transferring member 346, respectively. When the first dye transferring member 326, the second dye transferring member 336, and the third dye transferring member 346 each face the dye mounting layer on the recording intermediate belt 361, the first dye transferring member 326, the second dye transferring member 336, and the third dye transferring member 346 are each pressed onto the dye mounting layer of the recording intermediate belt 361 by the first dye transfer head 322, the second dye transfer head 332, and third dye transfer head 342, respectively. When the first dye transfer head 322, the second dye transfer head 332, and the third dye transfer head 342 perform respective image forming operations based on image data which has been processed by the image processing control section 220 (FIG. 1), the first dye, the second dye, and the third dye of the respective first dye transferring member 326, second dye transferring member 336, and third dye transferring member 346 are transferred to the recording intermediate belt 361.

The first dye, the second dye, and the third dye are transferred by the first dye transfer head 322, the second dye transfer head 332, and the third dye transfer head 342, respectively, in sequence onto the recording intermediate belt 361, resulting in formation of a full-color image on the dye mounting layer. The full-color image is formed in a predetermined image forming region of the recording intermediate belt 361. Following the image forming region in which the full-color image has been formed, a non-image forming region having an appropriate length is provided along the circularly moving direction of the recording intermediate belt 361. Following the non-image forming region, a full-color image is provided.

A recording paper holder 392 is provided downstream of the third dye transfer section 340 along the circularly moving direction of the recording intermediate belt 361, which accommodates a roll of recording paper 351 made of plain paper. The recording paper holder 392 is detachably attached to an image forming section housing. The recording paper 351 accommodated in the recording paper holder 392 is drawn from a lower portion thereof upward along a side portion of the third dye transfer section 340. The recording paper 351 is transported in an upper region of the recording paper holder 392 along with the recording intermediate belt 361 while being pressed onto the recording intermediate belt 361.

A recording paper transfer section 350 comprising a recording paper transfer roller 354, around which the recording paper 351 is wound, is provided at an upper portion of the recording paper holder 392. The recording paper transfer roller 354 draws the recording paper 351 above the recording paper holder 392. The recording paper transfer roller 354 of the recording paper transfer section 350 can be moved upward and downward. When the recording paper transfer roller 354 is moved upward, the recording paper 351 wound around the recording paper transfer roller 354 presses the outer surface of the-recording intermediate belt 361 on which a full-color image has been formed and which is transported from the platen drum 360 to the auxiliary roller 363.

A recording paper transfer head 352 which presses an inner surface of the recording intermediate belt 361 is provided over the recording paper transfer roller 354. The recording paper transfer head 352 also faces the recording paper transfer roller 354. The recording paper transfer head 352 is fixed so that the recording paper transfer head 352 presses on the inner surface of the recording intermediate belt 361. When the recording paper transfer roller 354 is moved upward, it contacts the recording intermediate belt 361 which is moved upward along with the recording paper 351. The recording intermediate belt 361 is pressed against the recording paper transfer head 352. In this case, when the recording paper transfer head 352 is heated, the full-color image formed on the dye mounting layer of the recording intermediate belt 361 is transferred onto the recording paper 351 wound around the recording paper transfer roller 354 together with the dye mounting layer. When the recording paper transfer roller 354 is moved downward, the recording intermediate belt 361 is positioned away from the recording paper transfer head 352. The temperature of the recording paper transfer head 352 is detected by the temperature sensor 442 provided in the vicinity of the recording paper transfer head 352.

The dye mounting layer transfer section 310, the first dye transfer section 320, the second dye transfer section 330, and the third dye transfer section 340 perform a transfer operation with respect to the recording intermediate belt 361 for a predetermined period of time. Specifically, a period of time for which the dye mounting layer transfer head 312 transfers the dye mounting layer, a period of time for which the first dye transfer section 320 transfers the first dye, a period of time for which the second dye transfer section 330 transfers the second dye, and a period of time for which the third dye transfer section 340 transfers the third dye are substantially equal to one another with respect to an image forming region of the recording intermediate belt 361.

In this situation, an image can be formed on the recording intermediate belt 361 transported at a substantially constant rate by the platen drum 360 rotating at a substantially constant rate.

The recording paper 351 having a full-color image transferred thereonto is transported together with the recording intermediate belt 361 to the auxiliary roller 363. The circularly moving direction of the recording intermediate belt 361 wound around the auxiliary roller 363 is changed to an upward direction along the auxiliary roller 363. On the other hand, the recording paper 351 having a full-color image transferred thereonto is peeled off the recording intermediate belt 361 and continues to move straight along the circularly moving direction of the recording intermediate belt 361 so as to be transported from the platen drum 360 to the auxiliary roller 363.

The cutting section 370 for cutting the recording paper 351 is provided downstream of the auxiliary roller 363 along the direction in which the recording paper 351 is moved straightforward. The straightforward moving recording paper 351 having a full-color image transferred thereonto is passed through the cutting section 370 while being cut by the cutting section 370 into regions having a predetermined size in which a full-color image is formed. The recording paper 351 which has been cut into image forming regions is transported to the reception opening 140 provided outside the image forming section 300.

The cut piece accommodating section 390 is provided under the cutting section 370, which accommodates cut pieces of the recording paper 351 generated when the recording paper 351 is cut. The cut piece accommodating section 390 is in the shape of a hollow box. Cut pieces generated when the recording paper 351 is cut by the cutting section 370 are accommodated in the cut piece accommodating section 390.

The cut piece fullness detecting section 382 is provided in the cut piece accommodating section 390, which determines whether or not the amount of cut pieces accommodated in the cut piece accommodating section 390 exceeds a predetermined level. The cut piece fullness detecting section 382 comprises a light emitting section 382a for emitting light and a light receiving section 382b for receiving light emitted by the light emitting section 382a. The light emitting section 382a and the light receiving section 382b are arranged so that when the amount of cut pieces accommodated in the cut piece accommodating section 390 is smaller than or equal to a predetermined level, the light receiving section 382b can receive light emitted from the light emitting section 382a, and when the amount of cut pieces accommodated in the cut piece accommodating section 390 exceeds the predetermined level, light emitted by the light emitting section 382a is intercepted by the cut pieces accommodated in the cut piece accommodating section 390 and the light receiving section 382b cannot receive the light emitted from the light emitting section 382a. Thus, the cut piece fullness detecting section 382 is provided so that the control section 200 can inform the user via the display section 120 that the amount of cut pieces accommodated in the cut piece accommodating section 390 exceeds a predetermined level. Therefore, the user can know when to discard the cut pieces accommodated in the cut piece accommodating section 390.

As described above, the cut piece fullness detecting section 382 determines whether or not the amount of cut pieces accommodated in the cut piece accommodating section 390 exceeds a predetermined level. It is possible that the cut piece fullness detecting section 382 detects a cut piece cut by the cutting section 370 which is falling in the cut piece accommodating section 390. When the cut piece fullness detecting section 382 detects a cut piece falling in the cut piece accommodating section 390, the cut piece fullness detecting section 382 erroneously determines that the amount of cut pieces accommodated in the cut piece accommodating section 390 exceeds a predetermined level even if the amount of cut pieces accommodated in the cut piece accommodating section 390 is lower than or equal to the predetermined level.

To avoid such erroneous detection, the cut piece fullness detecting section 382 suspends the detection operation for a predetermined period of time after the cutting section 370 cuts the recording paper 351. Thereby, it is possible to avoid the cut piece fullness detecting section 382 from erroneously detecting a cut piece which is falling in the cut piece accommodating section 390. The cut piece fullness detecting section 382 resumes a detection operation after the predetermined period of time has passed.

Alternatively, in order to avoid erroneously detecting a cut piece falling in the cut piece accommodating section 390, the light emitting section 382a may emit light at predetermined intervals. If the light receiving section 382b cannot receive the light for a predetermined time or more, it may be determined that the amount of cut pieces accommodated in the cut piece accommodating section 390 exceeds a predetermined level. This is because whereas a cut piece falling in the cut piece accommodating section 390 only intercepts light emitted the light emitting section 382a for a brief period of time, cut pieces accommodated in the cut piece accommodating section 390 continuously intercept light emitted by the light emitting section 382a.

A plurality of cut pieces generated by the cutting section 370 are accommodated in the cut piece accommodating section 390, entering the cut piece accommodating section 390 one after another. In this case, a volume occupied by the cut pieces accommodated in the cut piece accommodating section 390 is considerably larger than the actual volume of the cut pieces. This is because the cut pieces are sparsely accommodated in the cut piece accommodating section 390.

As described above, the volume of cut pieces accommodated in the cut piece accommodating section 390 may be large even if the actual volume of the cut pieces is not so large. In this case, the cut piece fullness detecting section 382 determines more frequently that the amount of cut pieces accommodated in the cut piece accommodating section 390 exceeds a predetermined level. Therefore, it is necessary to frequently discard cut pieces accommodated in the cut piece accommodating section 390.

However, the cut piece accommodating section 390 is provided with the cut piece volume reducing section 385 so that the volume of cut pieces can be reduced. An example of the cut piece volume reducing section 385 is a shaking section 385a which shakes the cut piece accommodating section 390. By shaking the cut piece accommodating section 390 periodically using the shaking section 385a, gaps between cut pieces accommodated in the cut piece accommodating section 390 can be reduced.

Another example of the cut piece volume reducing section 385 is a cut piece moving section 385b which moves cut pieces accommodated in the cut piece accommodating section 390. In the cut piece accommodating section 390, cut pieces may be concentrated into a particular location while cut pieces are not much accumulated at other locations. In this case, the cut piece fullness detecting section 382 erroneously determines that the amount of cut pieces accommodated in the cut piece accommodating section 390 exceeds a predetermined level. By moving the cut piece moving section 385b laterally, the accommodated cut pieces are moved laterally. Therefore, cut pieces falling from the cutting section 370 can be moved from a location at which the cut pieces are likely to be accumulated to another location. Thus, the erroneous detection can be avoided.

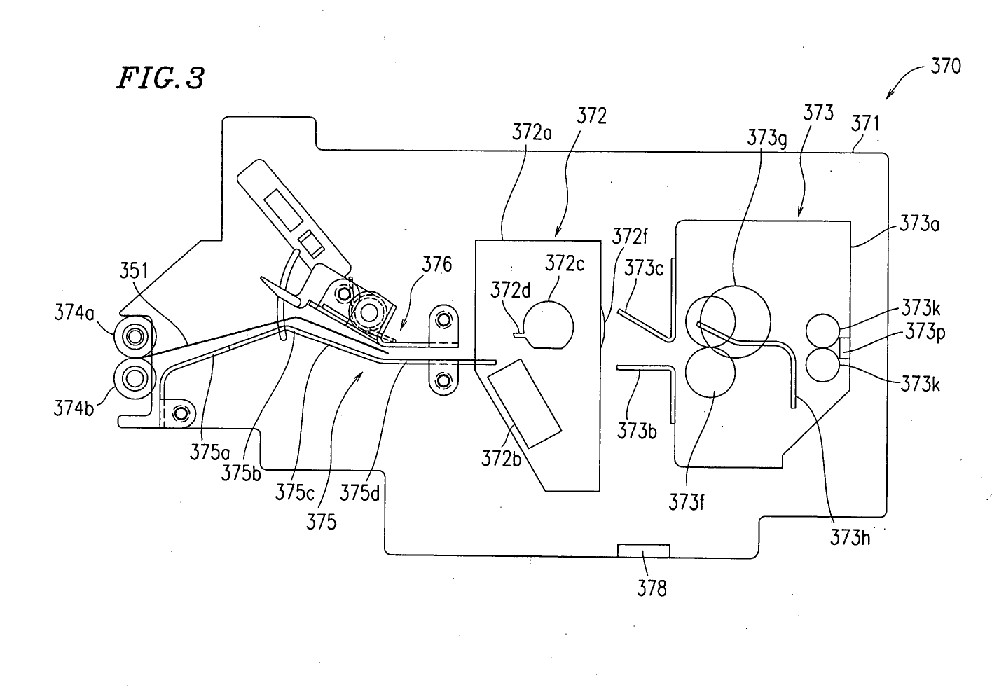

FIG. 3 is a side view showing a schematic structure of the cutting section 370 provided downstream of the recording paper holder 392 along the transporting direction of the recording paper 351. The cutting section 370 has a rotary cutter section 372 which is a first cutting mechanism for cutting the recording paper 351 in a width direction substantially perpendicular to the transporting direction, a slitter section 373 which is a second cutting mechanism for cutting each widthwise side portion of the recording paper 351 along the transporting direction, and a cutting section casing 371 in which the rotary cutter section 372 and the slitter section 373 are disposed.

The slitter section 373 is provided downstream of the recording paper 351 which is provided in the rectangular prism-like cutting section casing 371 along the transporting direction. The rotary cutter section 372 is provided upstream of the slitter section 373 with an appropriate space with respect to the slitter section 373. The rotary cutter section 372 is provided at substantially the middle of the cutting section casing 371 along the transporting direction of the recording paper 351.

The cutting section casing 371 comprises a pair of high and low introduction rollers 374a and 374b for introducing thereinto the recording paper 351, which has been peeled off the recording intermediate belt 361. The introduction rollers 374a and 374b are provided on an upstream side of the cutting section casing 371 along the transporting direction of the recording paper 351. The recording paper 351 is introduced through the pair of introduction rollers 374a and 374b into the cutting section casing 371.

The recording paper 351 which has been introduced into the cutting section casing 371 is transported to the rotary cutter section 372 by a recording paper guiding plate 375 provided in the cutting section casing 371. The recording paper guiding plate 375 has a upstream inclined portion 375a which is inclined deviating from the horizontal to a higher level from the introduction rollers 374a and 374b. A downstream inclined portion 375c is continuously linked with the upstream inclined portion 375a. The downstream inclined portion 375c is inclined deviating from the horizontal to a lower level toward a downstream portion. A linking portion of the upstream inclined portion 375a and the downstream inclined portion 375c, which is projected upward, is referred to as a bent portion 375b.

The downstream inclined portion 375c is linked with a horizontal guiding portion 375d horizontally extending toward the rotary cutter section 372. A downstream end of the horizontal guiding portion 375d with respect to the transporting direction of the recording paper enters the rotary cutter section 372.

The horizontal guiding portion 375d of the recording paper guiding plate 375 is positioned near the rotary cutter section 372. An upper guiding plate 376 is provided above the horizontal guiding portion 375d with a predetermined space.

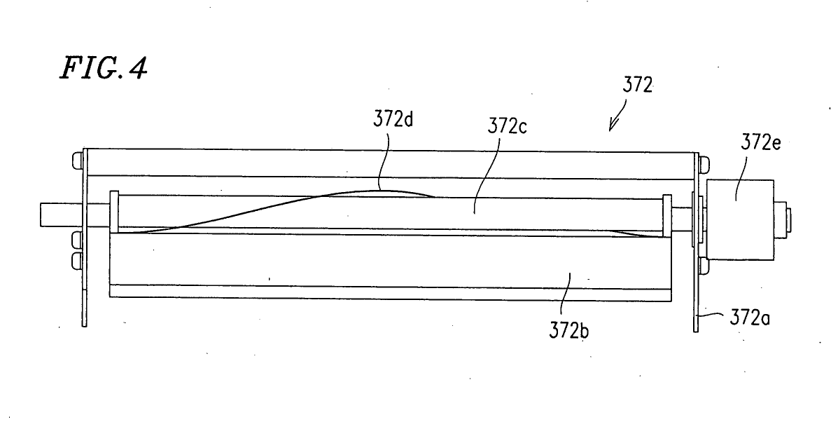

FIG. 4 is a schematic front view showing the rotary cutter section 372 provided downstream of the recording paper guiding plate 375 with respect to the transporting direction of the recording paper. The rotary cutter section 372 has a fixed blade 372b provided at a lower portion of a cutter case 372a and along a direction substantially perpendicular to the transporting direction of the recording paper 351, and a rotary blade 372c provided above the fixed blade 372b, where a transporting area of the recording paper 351 is interposed by the blades 372c and 372b. The rotary blade 372c is in the shape of a cylinder and can be rotated around an axis substantially perpendicular to the transporting direction of the recording paper 351. A helical blade 372d is provided on a circular surface of the rotary blade 372c.

The rotary blade 372c is driven by a motor 372e provided on an outer side of the cutter case 372a to be rotated in a predetermined direction. When the recording paper 351 is transported into the cutter case 372a and is passed between the fixed blade 372b and the rotary blade 372c over a distance of a predetermined length, the motor 372e drives and rotates the rotary blade 372c. The recording paper 351 is cut widthwise by shearing forces occurring between the helical blade 372d of the rotated rotary blade 372c and the fixed blade 372b. A cut portion of the recording paper 351 is ejected from an eject opening 372f provided in the cutter case 372a via an opening portion 378 to the outside of the cutter case 372a. The motor 372e is controlled by the mechanism control section 230 (FIG. 1) so as to be rotated at predetermined timings.

As described above, the recording intermediate belt 361 has an image forming region followed by a non-image forming region extending over a distance of an appropriate length in the circularly moving direction. Following the non-image forming region, another image forming region is provided. In this manner, the recording intermediate belt 361 has image forming regions having a predetermined length and non-image forming regions having a length shorter than the length of the image forming region, which are alternately arranged.

The recording paper 351 is transported together with the recording intermediate belt 361. Images on the recording intermediate belt 361 are successively transferred onto the recording paper 351 at intervals corresponding to the length of the non-image forming region.

The rotary cutter section 372 functions as follows. After the recording paper 351 having a transferred image thereof has been transported over a distance of a length of an image forming region along the transporting direction of the recording paper, the rotary cutter section 372 starts cutting the recording paper 351 along a direction substantially perpendicular to the transporting direction and cuts a non-image forming region of the recording paper 351 a plurality of times while the recording paper 351 is transported over a distance of a length of the non-image forming region along the transporting direction. Therefore, the rotary cutter section 372 is controlled by the mechanism control section 230 (FIG. 1) so that non-image forming regions of the recording paper 351 are cut a plurality of times in a direction substantially perpendicular to the transporting direction without cutting image forming regions of the recording paper 351.

In this case, a cutting width over which the rotary cutter section 372 cuts a non-image forming region is a size such that the resultant cut pieces can pass through the opening portion 378, and the recording paper 351 does not get jammed in the rotary cutter section 372.

The length of a non-image forming region may vary depending on the size of an image forming region adjacent to the non-image forming region. The control section 200 specifies the length of a non-image forming region along the transporting direction, and based on the length, changes the cutting width within a range such that cut pieces can pass through the opening portion 378, and the recording paper 351 does not get jammed in the rotary cutter section 372.

Referring back to FIG. 3, the slitter section 373 provided downstream of the rotary cutter section 372 along the transporting direction of the recording paper 351 has a slitter case 373a. A lower introduction guiding plate 373b and an upper introduction guiding plate 373c are provided on a side of the slitter case 373a facing the rotary cutter section 372, which guides a portion of the recording paper 351 cut off by the rotary cutter section 372 to be introduced into the slitter case 373a.

The lower introduction guiding plate 373b and the upper introduction guiding plate 373c extend from the slitter case 373a of the slitter section 373 toward the rotary cutter section 372. The lower introduction guiding plate 373b extends horizontally. The upper introduction guiding plate 373c is inclined deviating from the horizontal to a higher level toward the upstream of the transporting direction of the recording paper. The lower introduction guiding plate 373b is positioned slightly lower than the eject opening 372f of the cutter case 372a through which the recording paper 351 is ejected from the rotary cutter section 372.

A tip portion of the lower introduction guiding plate 373b closer to the rotary cutter section 372 is positioned with an appropriate horizontal interval with respect to the eject opening 372f of the cutter case 372a through which the recording paper 351 is ejected from the rotary cutter section 372. The interval between the lower introduction guiding plate 373b and the cutter case 372a of the rotary cutter section 372 is slightly longer than the maximum cutting width of a non-image forming region cut by the rotary cutter section 372.

As described above, the rotary cutter section 372 and the slitter section 373 are positioned with an interval which is slightly longer than the maximum cutting width of a non-image forming region cut by the rotary cutter section 372. Therefore, the recording paper 351 is cut a plurality of times by the rotary cutter section 372 over a distance of a length corresponding to a non-image forming region. When the cut pieces of the non-image forming region are ejected through the eject opening 372f of the rotary cutter section 372, the cut pieces fall through a space between the cutter case 372a of the rotary cutter section 372 and the lower introduction guiding plate 373b of the slitter section 373 without reaching the lower introduction guiding plate 373b of the slitter section 373.

The opening portion 378 is provided on a lower side of the cutting section casing 371 of the cutting section 370. The cut piece accommodating section 390 (FIG. 2) is provided under the opening portion 378. Therefore, the recording paper 351 falling between the cutter case 372a of the rotary cutter section 372 and the lower introduction guiding plate 373b of the slitter section 373 is passed through the opening portion 378 of the cutting section casing 371 and is accommodated in the cut piece accommodating section 390 (FIG. 2).

In contrast to this, the recording paper 351 having an image an an image forming region thereof, which has been cut into a length corresponding to the length of the image forming region in the rotary cutter section 372, is transported out through the cutter case 372a of the rotary cutter section 372, is then supported by the lower introduction guiding plate 373b, and is introduced into the slitter case 373a through the space between the lower introduction guiding plate 373b and the upper introduction guiding plate 373c.

A pair of high and low eject rollers 373k for ejecting the recording paper 351, whose side edges have been cut off, to the outside of the slitter case 373a are provided in a downstream portion of the slitter case 373a of the slitter section 373 with respect to the transporting direction of the recording paper. The recording paper 351, whose side edges have been cut off, is sandwiched by the eject rollers 373k, and is ejected through an eject opening 373p provided in the slitter case 373a. The recording paper 351 which has been ejected through the eject opening 373p of the slitter case 373a is sent to the reception opening 140 (FIG. 1).

Side edges of the recording paper 351 are cut off by a lower cutter 373f and an upper cutter 373g of the slitter section 373. The resultant cut pieces are guided along lower sides of cut piece guiding plates 373h. The cut pieces are transported downward by bent portions of the respective cut piece guiding plate 373h.

An eject opening is provided on a lower side of the slitter case 373a of the slitter section 373, through which the side edge cut pieces whose transporting direction is bent downward by the cut piece guiding plates 373h are ejected downward. Cut pieces ejected downward through the eject opening are passed through an opening portion provided on a lower side of the cutting section casing 371 of the cutting section 370, and are then accommodated in the cut piece accommodating section 390.

Thus, in the cutting section 370, the recording paper 351 is cut into a length corresponding to a length of an image forming region by the rotary cutter section 372, and thereafter, is cut over a length corresponding to a length of a non-image forming region. The resultant non-image forming region cut pieces are accommodated into the cut piece accommodating section 390 provided thereunder without being transported into the slitter section 373. Therefore, only a portion of the recording paper 351 corresponding to an image forming region is transported into the slitter section 373. Side edges of the portion of the recording paper 351 are cut off by the slitter section 373.

Thus, the recording paper 351 having a predetermined length facilitates the cutting operation of the slitter section 373. In addition, since the recording paper 351 which has been cut into a predetermined length is transported into the slitter section 373 which in turn cuts the cut piece, there is not a risk of a cut trace remaining on a tip portion of the recording paper 351 due to the slitter section 373 when the recording paper 351 is rolled back after a predetermined number of images have been formed on the recording paper 351.

Side edge cut pieces generated by the slitter section 373 are ejected by the cut piece guiding plates 373h into the cut piece accommodating section 390. Therefore, there is not a risk of the side edge cut pieces generated by the slitter section 373 remaining in the rotary cutter section 372. As a result, only a predetermined-size portion of the recording paper 351 on which an image has been formed and has been cut out is sent to the reception opening 140 (FIG. 1) provided outside the image forming section 300.

If any one of the temperatures of the dye mounting layer transfer head 312, the first dye transfer head 322, the second dye transfer head 332, the third dye transfer head 342, and the recording paper transfer head 352 determined by the respective temperature sensors 402, 412, 422, 432, and 442 reaches a predetermined temperature, the control section 200 (FIG. 1) specifies the number of remaining images to be formed. If the number of remaining images to be formed is smaller than or equal to a predetermined number (e.g., three, etc.), the control section 200 permits the image forming section 300 to continue to form the remaining images. If the number of remaining images to be formed is greater than the predetermined number, the control section 200 stops heating the dye mounting layer transfer head 312, the first dye transfer head 322, the second dye transfer head 332, the third dye transfer head 342, and the recording paper transfer head 352, and brings the image forming section 300 into a cooling state. The image forming section 300 in the cooling state does not form images, the heat of the dye mounting layer transfer head 312, the first dye transfer head 322, the second dye transfer head 332, the third dye transfer head 342, and the recording paper transfer head 352 is released. The cooling state is continued until the temperatures of the dye mounting layer transfer head 312, the first dye transfer head 322, the second dye transfer head 332, the third dye transfer head 342, and the recording paper transfer head 352 are lower than or equal to a predetermined temperature. Thereafter, the control section 200 permits the image forming apparatus 300 to form the remaining images.

Thus, the control section 200 can determine whether or not the transition into the cooling state is performed, depending on the number of remaining images to be formed. Even when any one of the dye mounting layer transfer head 312, the first dye transfer head 322, the second dye transfer head 332, the third dye transfer head 342, and the recording paper transfer head 352 has a temperature higher than a predetermined temperature, image production is not affected if a limited number of images remain to be produced. Therefore, the image forming section 300 is not put into a cooling state if a small number of images remain to be formed, thereby making it possible to reduce the user's waiting time.

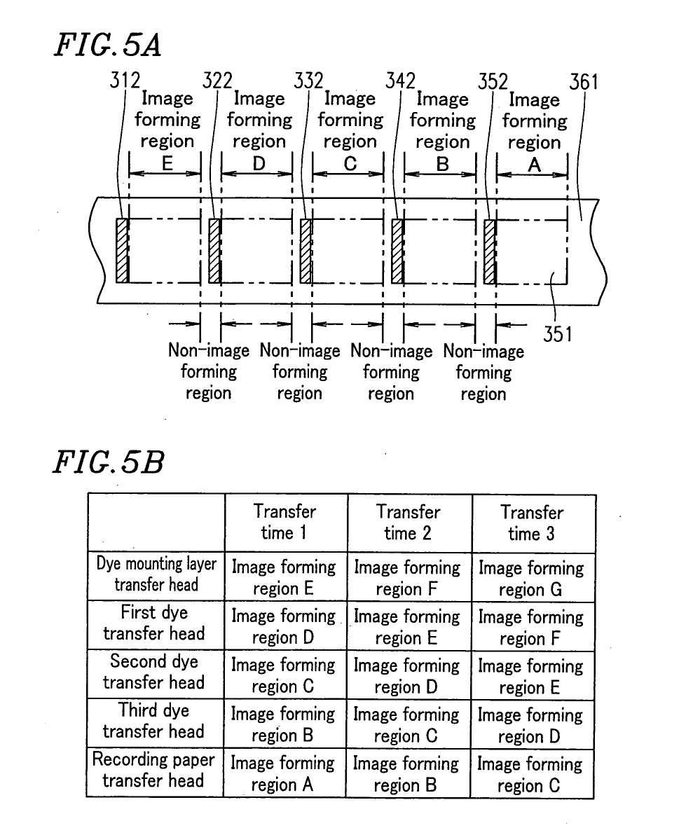

FIG. 5A is a schematic plan view for explaining how images A to E are successively formed on image forming regions A to E of the recording intermediate belt 361.

The image forming regions A to E are disposed in sequence on the recording intermediate belt 361, where a non-image forming region is provided between each image forming region A to E.

As shown in FIG. 5A, the dye mounting layer transfer head 312 of the dye mounting layer transfer section 310 and the first dye transfer head 322 of the first dye transfer section 320 are spaced by an interval slightly longer than a length of an image forming region having a size equal to a predetermined image size along the circularly moving direction of the recording intermediate belt 361. For example, if an image forming region has the A6 size, the dye mounting layer transfer head 310 and the first dye transfer head 322 are spaced by 110 mm which is longer than the length of the image forming region.

Similarly, the first dye transfer head 322 of the first dye transfer section 320 and the second dye transfer head 332 of the second dye transfer section 330 are spaced by an interval slightly longer than a length of an image forming region having a size equal to a predetermined image size along the circularly moving direction of the recording intermediate belt 361. Also similarly, the second dye transfer head 332 of the second dye transfer section 330 and the third dye transfer head 342 of the third dye transfer section 340 are spaced by an interval slightly longer than a length of an image forming region having a size equal to a predetermined image size along the circularly moving direction of the recording intermediate belt 361.

Therefore, when the third dye transfer head 342 of the third dye transfer section 340 faces a first non-image forming region of the recording intermediate belt 361, the second dye transfer head 332 of the second dye transfer section 330 faces a second non-image forming region spaced apart from the first non-image forming region by an image forming region, and the first dye transfer head 322 of the first dye transfer section 320 faces a third non-image forming region spaced apart from the second non-image forming region by an image forming region. Further, the dye mounting layer transfer head 312 of the dye mounting layer transfer section 310 faces a fourth non-image forming region spaced apart from the third non-image forming region by an image forming region.

FIG. 5B is a table for explaining how the dye mounting layer transfer head 312, the first dye transfer head 322, the second dye transfer head 332, the third dye transfer head 342, and the recording paper transfer head 352 simultaneously transfer images onto image forming regions. Here, transfer time 1 to 3 will be illustrated and described. Note that the transfer time is continued in an actual situation.

At the transfer time 1, the recording paper transfer head 352 transfers an image A which has been formed in the image forming region A onto a recording paper; the third dye transfer head 342 transfers the third dye of an image B onto the image forming region B; the second dye transfer head 332 transfers the second dye of an image C onto the image forming region C; the first dye transfer head 322 transfers the first dye of an image D onto the image forming region D; and the dye mounting layer transfer head 312 transfers a dye mounting layer onto the image forming region E. FIG. 5A shows a state at the transfer time 1.

Next, at the transfer time 2, the recording paper transfer head 352 transfers the image B which has been formed in the image forming region B onto the recording paper; the third dye transfer head 342 transfers the third dye of the image C onto the image forming region C; the second dye transfer head 332 transfers the second dye of the image D onto the image forming region D; the first dye transfer head 322 transfers the first dye of an image E onto the image forming region E; and the dye mounting layer transfer head 312 transfers a dye mounting layer into the image forming region F.

Next, at the transfer time 3, the recording paper transfer head 352 transfers the image C which has been formed in the image forming region C onto the recording paper; the third dye transfer head 342 transfers the third dye of the image D into the image forming region D; the second dye transfer head 332 transfers the second dye of the image E into the image forming region E; the first dye transfer head 322 transfers the first dye of the image F into the image forming region F; and the dye mounting layer transfer head 312 transfers a dye mounting layer into an image forming region G.

As described above, the image forming section 300 transfers dyes to form images. The image forming section 300 does not only perform a dye transfer operation but may also be in a standby state where it is waiting for the time of a dye transfer operation.

If no user appears at the image forming apparatus 100 for a predetermined period of time or more or no input is entered into the input section 130 of the image forming apparatus 100 for a predetermined period of time, the image forming section 300 goes into the standby state. After the image forming apparatus 100 has formed an image, if no input is entered into the input section 130 for a predetermined period of time (e.g., 5 minutes), the image forming section 300 is changed from the dye transfer operation state to the standby state.

Hereinafter, a state transition of the image forming section 300 will be described, in which after the image forming section 300 has formed a last image, the image forming section 300 is changed from the dye transfer operation state to the standby state. Specifically, the first dye transfer section 320 of the image forming section 300 will be described. The description can be similarly applied to the second dye transfer section 330 and the third dye transfer section 340.

Even after the first dye transfer section 320 transfers the first dye into an image forming region to form a last image, the roller 325 continues to take up the first dye transferring member 326 until the second dye transfer section 330 transfers the second dye into the image forming region, the third dye transfer section 340 transfers the third dye, and these dyes are transferred onto the recording paper 351. Therefore, after the image forming section 300 has formed a last image, a portion of the first dye transferring member 326 which has not been used faces the recording intermediate belt 361 in the first dye transfer section 320. If the first dye transfer section 320 is allowed to stand in this state, dust is likely to be attached to the unused portion of the first dye transferring member 326. If such a first dye transferring member 326 is used to form the next image, the image is likely to be unclear. Therefore, when the image forming section 300 is changed from the dye transfer operation state to the standby state, the first dye transferring member 326 is wound backward by rotating the motor 328 of the first dye transfer section 320 so that a used portion of the first dye transferring member 326 faces the recording intermediate belt 361.

In order to wind back the first dye transferring member 326 so that a used portion of the first dye transferring member 326 faces the recording intermediate belt 361, the mechanism control section 230 drives the motor 328 to rotate the roller 329 in a backward direction, thereby winding the first dye transferring member 326 in a backward direction. In this case, the roller 325 is rotated in a backward direction by the rotation of the roller 329.

The image forming section 300 waits for resumption of image formation in a standby state where a used portion of the first dye transferring member 326 faces the recording intermediate belt 361.

Next, when image formation is resumed, the motor 324 of the first dye transfer section 320 is driven to rotate the roller 325 so that the used portion of the first dye transferring member 326 is taken up and an unused portion of the first dye transferring member 326 faces the recording intermediate belt 361. Thereafter, the first dye transfer section 320 transfers the first dye onto the recording intermediate belt 361.

As described above, in the standby state a used portion of the first dye transferring member 326 faces the recording intermediate belt 361 in the first dye transfer section 320. When the image forming section 300 is changed from the standby state to the dye transfer operation state, an unused portion of the first dye transferring member 326 faces the recording intermediate belt 361. Therefore, it is possible to prevent dust from being attached to a portion of the first dye transferring member 326 which is used for image formation. In addition, owing to the standby state, it is unnecessary to constantly heat the first dye transfer head 322, thereby making it possible to suppress an increase in power consumption.

In the foregoing description, the standby state and the dye transfer operation state of the first dye transfer section 320 and the transition thereof from the standby state to the dye transfer operation state have been explained. The description is not limited to the first dye transfer section 320. The second dye transfer section 330 and the third dye transfer section 340 can be similarly operated to achieve the same advantage as that which is described above with respect to the first dye transfer section 320.

It is preferable that when the image forming section 300 is changed from the standby state to the dye transfer operation state, a circular length of the recording intermediate belt 361 is determined. This is because the circular length of the recording intermediate belt 361 varies depending on the ambient environment (e.g., the ambient temperature of the image forming apparatus 100). In this case, the recording intermediate belt full length detecting section 365 is used to detect a detectable mark attached to the recording intermediate belt 361 twice while circularly moving the recording intermediate belt 361 by rotating the platen drum 360 at a predetermined rate. Based on a period of time between the first mark detection and the second mark detection and the rotational rate of the platen drum 360, the mechanism control section 230 can determine the circular length of the recording intermediate belt 361. The mechanism control section 230 can change the rotational rate of the platen drum 360 in accordance with the determined length.

It is preferable that the transition from the standby state to the dye transfer operation state begins with the start of the image forming apparatus 100 by the user. Specifically, when the input section 130 of the image forming apparatus 100 receives any input, the control section 200 permits the image forming apparatus 300 to be changed from the standby state to the dye transfer operation state.

When the user establishes the settings for a desired image to be formed via the display section 120 and the input section 130, the image forming apparatus 300 has already been changed from the standby state to the dye transfer operation state. The image forming apparatus 300 can form images immediately based on the user's instructions.

The image forming apparatus 100 is adjusted so as to form images at a desired density before shipment. This is because even if the identical image forming apparatuses 100 as fabricated in the same manner to form images under the same conditions, the density in images formed by the image forming apparatuses 100 slightly varies from apparatus to apparatus.

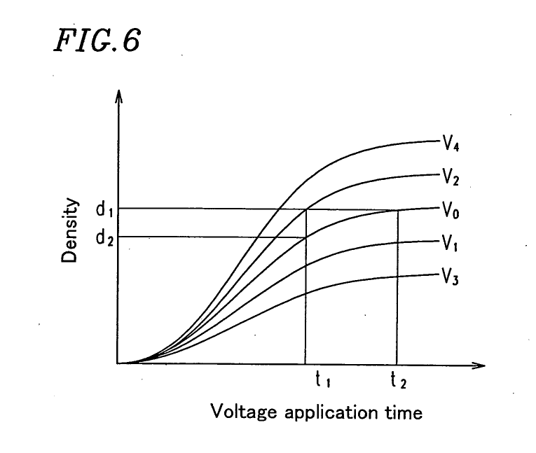

FIG. 6 is a graph showing a correction table for adjusting the image forming apparatus 100 according to an embodiment of the present invention before shipment so that images having a desired density can be formed. The graph shows a relationship between a period of time during which a voltage is applied to a reference first dye transfer head and the density of an image transferred by the reference first dye transfer head, where the reference first dye transfer head is used as a reference with respect to the first dye transfer head 322 (FIG. 2) and the voltage is a reference voltage V₀ and a plurality of voltages V₁, V₂, V₃ and V₄ are near to the reference voltage V₀. In FIG. 6, the horizontal axis represents the voltage application time and the vertical axis represents the density. The reference voltage V₀ is a voltage which is considered to be actually applied to the image forming apparatus 100.

Here, the voltages have the following relationship: V₃<V₁<V₀<V₂<V₄. The control section 200 stores a correction table indicating the relationship which has been measured in advance using the reference first dye transfer head.

Before shipment, the density of images formed by the image forming apparatus 100 are adjusted.

By operating the first dye transfer head 322 of the image forming apparatus 100 for a predetermined of time t₁ to transfer the first dye, the density of the transferred dye is measured. It is assumed that the density is d₁. Thereafter, a voltage corresponding to the reference first dye transfer head is determined based on the relationship between a predetermined period of time t₁ and the density d₁ in the correction table. Here, the corresponding voltage is V₂.

In this case, the control section 200 adjusts the control of the first dye transfer head 322, assuming that the first dye transfer head 322 has the relationship between the voltage application time and the density corresponding to that of the reference first dye transfer head where the voltage is V₂.

If there is no manufacturing variation between the first dye transfer head 322 and the reference first dye transfer head, the density of the transferred first dye should be density d₂ when the reference voltage V₀ is applied to the first dye transfer head 322 for a period of time t₁. However, since there is actually a manufacturing variation between the first dye transfer head 322 and the reference first dye transfer head, the density of the transferred first dye is density d₁ when the reference voltage V₀ is applied to the first dye transfer head 322 for a period of time t₁.

Therefore, the control section 200 adjusts the control of the first dye transfer head 322, assuming that the first dye transfer head 322 has the relationship between the voltage application time and the density corresponding to that of the reference first dye transfer head where the voltage is V₂. Thereby, the first dye transfer head 322 can transfer dye at a desired density. In other words, the density of the first dye is corrected by changing a period of voltage application time for a desired density using the correction table. Thus, manufacturing variations in the first dye transfer head 322 can be corrected by only changing the voltage application time.

In the foregoing description, the control of the first dye transfer head 322 was adjusted based on the correction table which has been prepared using the reference first dye transfer head. By using a reference second dye transfer head and a reference third dye transfer head, the above-described technique can be applied to the second dye transfer head 332 and the third dye transfer head 342.

As described above, before shipment of the image forming apparatus 100, the first dye transfer head 322, the second dye transfer head 332, and the third dye transfer head 342 are operated with a predetermined voltage for a predetermined period of time and the density of transferred dye is measured. The correction table is looked up for each of the reference first dye transfer head, the reference second dye transfer head, and the reference third dye transfer head so as to determine what voltages correspond to the density. Thereby, it is possible to adjust a period of voltage application time for the first dye transfer head 322, the second dye transfer head 332, and the third dye transfer head 342 so that dye can be transferred at a desired density.

According to the present invention, an image forming apparatus is provided, which prevents dust from being attached to a portion of a dye transferring member which is used for image formation, i.e., prevents formation of unclear images.

According to the present invention, it is possible to detect an end of a dye mounting layer transfer section.

According to the present invention, an image forming apparatus is provided, which does not provide to the user an image to which a dye of a dye transferring member is not transferred due to exhaustion of the dye.

According to the present invention, even when at least one of a dye mounting layer transfer head, dye transfer heads, and a recording paper transfer head exceeds a predetermined temperature, remaining images are formed if the number of the remaining images is small. After the remaining images are formed, the dye mounting layer transfer head, the dye transfer heads, and the recording paper transfer head can be put into a cooling state. Thus, it is possible to avoid keeping the user waiting until a cooling state is completed before the remaining images are formed.

According to the present invention, when recording paper having image forming regions and non-image forming regions which are arranged alternately along the transporting direction is cut by a cutting section a plurality of times in the non-image forming regions along a direction substantially perpendicular to the transporting direction, the cutting section can cut the non-image forming region of the recording paper into cut pieces having a size such that the cut pieces can pass through an opening portion.

According to the present invention, it is possible to avoid erroneously determining that the amount of cut pieces accommodated in the cut piece accommodating section exceeds a predetermined level in the situation where falling cut pieces intercept light for determining whether or not the amount of cut pieces accommodated in a cut piece accommodating section exceeds a predetermined level.

According to the present invention, cut pieces are prevented from being sparsely accommodated in a cut piece accommodating section, thereby making it possible to avoid the situation that the cut piece accommodating section is frequently detected as being full.

According to the present invention, the voltage application time of a dye transfer head is adjusted instead of a voltage applied to the dye transfer head in order to compensate for variations in dye transfer heads, thereby making it possible to adjust the density of dye transferred by the dye transfer head.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An image forming apparatus, comprising:
a dye transfer section for transferring a dye of a dye transferring member onto an outer surface of a circularly moving recording intermediate belt, wherein the dye transferring member comprises a base material and the dye is provided on the base material; and
a recording paper transfer section for transferring the dye transferred onto the recording intermediate belt onto recording paper,
wherein the dye transfer section comprises a first roller and a second roller, wherein the dye transferring member is wound around the first roller, and the second roller draws out the dye transferring member from the first roller,
wherein in a dye transfer operation state, the second roller draws out the dye transferring member and the dye on the drawn dye transferring member is transferred onto the recording intermediate belt facing the dye transferring member, and
when the dye transfer operation state is changed to a standby state, the first roller winds back the dye transferring member so that a portion of the dye transferring member from which the dye has been transferred faces the recording intermediate belt.

2. An image forming apparatus according to claim 1, wherein when the standby state is changed to the dye transfer operation state, the second roller draws out the dye transferring member so that a portion of the dye transferring member from which the dye has not been transferred faces the recording intermediate belt.

3. An image forming apparatus, comprising:
a dye mounting layer transfer section for transferring a dye mounting layer of a dye mounting layer transferring member onto an outer surface of a circularly moving recording intermediate belt, wherein the dye mounting layer transferring member comprises a base material and the dye mounting layer is provided on the base material;
a dye transfer section for transferring a dye of a dye transferring member onto the dye mounting layer, wherein the dye transferring member comprises a base material and the dye is provided on the base material; and
a recording paper transfer section for transferring the dye transferred onto the recording intermediate belt onto recording paper,
wherein the dye mounting layer transfer section comprises a first roller and a second roller, wherein the dye mounting layer transferring member is wound around the first roller, and the second roller draws out the dye mounting layer transferring member from the first roller, and
an end of the dye mounting layer transferring member is detected by determining a remaining amount of the dye mounting layer transferring member wound around the first roller based on a rotational rate of the second roller.

4. An image forming apparatus, comprising:
a plurality of dye transfer sections for transferring dyes of respective dye transferring members onto an outer surface of a circularly moving recording intermediate belt, wherein each dye transferring member comprises a base material and the dye is provided on the base material;
a recording paper transfer section for transferring the dyes transferred onto the recording intermediate belt in sequence onto transported recording paper drawn out from a roll of the recording paper, wherein image forming regions are spaced by non-image forming regions, the dyes are transferred into the respective image forming regions and the dyes are not transferred into the non-image forming regions; and
a cutting section for cutting the recording paper having the dye transferred thereon by the recording paper transfer section into the image forming regions,
wherein each dye transfer section comprises a dye transferring member exhaustion detecting section for detecting when the dye of the dye transferring member thereof is exhausted, and
when any one of the dye transferring member exhaustion detecting sections detects dye exhaustion, the cutting section cuts an image forming region of the recording paper on which an image is formed with the dyes of the dye transferring members other than the exhausted dye of the dye transferring member.

5. An image forming apparatus, comprising:
a dye mounting layer transfer section for transferring a dye mounting layer of a dye mounting layer transferring member onto an outer surface of a circularly moving recording intermediate belt using a heated dye mounting layer transfer head, wherein the dye mounting layer transferring member comprises a base material and the dye mounting layer is provided on the base material;
a dye transfer section for transferring a dye of a dye transferring member onto the dye mounting layer using a heated dye transfer head, wherein the dye transferring member comprises a base material and the dye is provided on the base material; and
a recording paper transfer section for transferring the dye transferred onto the dye mounting layer onto recording paper using a recording paper transfer head,
wherein temperature sensors are provided for detecting temperatures of the dye mounting layer transfer head, the dye transfer head, and the recording paper transfer head, respectively; the number of remaining images to be formed is specified; and the image forming apparatus is put into a cooling state, where the dye mounting layer transfer head, the dye transfer head, and the recording paper transfer head are cooled, based on at least one of the temperatures of the dye mounting layer transfer head, the dye transfer head, and the recording paper transfer head detected by the respective temperature sensors and the number of remaining images to be formed.

6. An image forming apparatus, comprising:
a dye transfer section for transferring a dye of a dye transferring member onto an outer surface of a circularly moving recording intermediate belt, wherein the dye transferring member comprises a base material and the dye is provided on the base material;
a recording paper transfer section for transferring the dyes transferred onto the recording intermediate belt in sequence onto transported recording paper drawn out from a roll of the recording paper, wherein image forming regions are spaced by non-image forming regions, the dyes are transferred into the respective image forming regions and the dyes are not transferred into the non-image forming regions; and
a cutting section for cutting the recording paper having the dye transferred by the recording paper transfer section into the image forming regions,
wherein the cutting section cuts a non-image forming region of the recording paper in a direction substantially perpendicular to a transporting direction of the recording paper based on a length of the non-image forming region along the transporting direction.

7. An image forming apparatus, comprising:
a dye transfer section for transferring a dye of a dye transferring member onto an outer surface of a circularly moving recording intermediate belt using a dye transfer head, wherein the dye transferring member comprises a base material and the dye is provided on the base material; and
a recording paper transfer section for transferring the dyes transferred onto the recording intermediate belt in sequence onto transported recording paper drawn out from a roll of the recording paper, wherein image forming regions are spaced by non-image forming regions, the dyes are transferred into the respective image forming regions and the dyes are not transferred into the non-image forming regions;
a cutting section for cutting the recording paper having the dye transferred thereon by the recording paper transfer section into the image forming regions;
a cut piece accommodating section for accommodating cut pieces generated by the cutting section; and
a cut piece fullness detecting section for determining whether or not an amount of cut pieces accommodated in the cut piece accommodating section exceeds a predetermined level,
wherein the cut piece fullness detecting section suspends the determination operation for a predetermined period of time after the cutting operation of the recording paper and thereafter resumes the determination operation.

8. An image forming apparatus, comprising:
a dye transfer section for transferring a dye of a dye transferring member onto an outer surface of a circularly moving recording intermediate belt, wherein the dye transferring member comprises a base material and the dye is provided on the base material;
a recording paper transfer section for transferring the dyes, which has been transferred onto the recording intermediate belt, in sequence onto transported recording paper drawn out from a roll of the recording paper, wherein image forming regions are spaced by non-image forming regions, the dyes are transferred into the respective image forming regions and the dyes are not transferred into the non-image forming regions;
a cutting section for cutting the recording paper having the dye transferred thereon by the recording paper transfer section into the image forming regions;
a cut piece accommodating section for accommodating cut pieces generated by the cutting section; and
a cut piece fullness detecting section for determining whether or not an amount of cut pieces accommodated in the cut piece accommodating section exceeds a predetermined level,
wherein the cut piece fullness detecting section emits light to the cut pieces accommodated in the cut piece accommodating section at predetermined intervals, and based on a number of light interceptions, determines whether or not an amount of the cut pieces accommodated in the cut piece accommodating section exceeds a predetermined level.

9. An image forming apparatus, comprising:
a dye transfer section for transferring a dye of a dye transferring member onto an outer surface of a circularly moving recording intermediate belt, wherein the dye transferring member comprises a base material and the dye is provided on the base material;
a recording paper transfer section for transferring the dyes transferred onto the recording intermediate belt in sequence onto transported recording paper drawn out from a roll of the recording paper, wherein image forming regions are spaced by non-image forming regions, the dyes are transferred into the respective image forming regions and the dyes are not transferred into the non-image forming regions;
a cutting section for cutting the recording paper having the dye transferred thereon by the recording paper transfer section into the image forming regions;
a cut piece accommodating section for accommodating cut pieces generated by the cutting section; and
a cut piece volume reducing section for reducing a volume of the cut pieces accommodated in the cut piece accommodating section.

10. A correction method for an image forming apparatus, wherein the image forming apparatus comprises:
a dye transfer section for transferring a dye of a dye transferring member onto an outer surface of a circularly moving recording intermediate belt using a dye transfer head, wherein the dye transferring member comprises a base material and the dye is provided on the base material, and the dye transfer head is heated by applying a predetermined voltage thereto for a predetermined period of time; and
a recording paper transfer section for transferring the dye transferred onto the recording intermediate belt onto recording paper,
wherein a reference dye transfer head as a reference for the dye transfer head is previously used to obtain a relationship among a density of a transferred dye, a period of voltage application time, and an applied voltage, and
the method comprises the steps:
measuring a density of the dye transferred by the dye transfer head by applying a first voltage thereto for a first period of voltage application time;
determining an appropriate voltage from the correction table based on the density measured by the measuring step and the first period of voltage application time; and
controlling the dye transfer head based on the relationship between the density of the dye transferred by applying the determined voltage to the reference dye transfer head and the period of voltage application time.
